(19) United States
(12) Patent Application Publication
(10) Pub. No.: US 2012/0098448 A1
(43) Pub. Date: Apr. 26, 2012

(54) LIGHT EMITTING DIODE DRIVING DEVICE

(75) Inventors: Hyun Gu KANG, Ansan-si (KR); Soung Hwi PARK, Ansan-si (KR)

(73) Assignees: INNOVISION CO., LTD., Seoul (KR); SEOUL SEMICONDUCTOR CO., LTD., Seoul (KR)

(21) Appl. No.: 13/276,630

(22) Filed: Oct. 19, 2011

(30) Foreign Application Priority Data
Oct. 20, 2010 (KR) 10-2010-0102657
Mar. 4, 2011 (KR) 10-2011-0019213

(51) Int. Cl. H05B 37/02

(52) U.S. Cl. 315/201

(57) ABSTRACT

An exemplary embodiment of the present invention discloses a light emitting diode (LED) driving device for an LED device having a plurality of LEDs, the driving device including a rectifying unit configured to receive an alternating current (AC) voltage and output a rectified voltage, and a driving control unit configured to drive the plurality of LEDs based on stored data by receiving the rectified voltage at a first period.

### CROSS-REFERENCE TO RELATED APPLICATIONS

This application claims priority from and the benefit of Korean Patent Application No. 10-2010-0102657, filed on Oct. 20, 2010, and Korean Patent Application No. 10-2011-0019213, filed on Mar. 04, 2011, which are both hereby incorporated by reference for all purposes as if fully set forth herein.

### BACKGROUND OF THE INVENTION

1. Field of the Invention

The present invention relates to a light emitting diode (LED) driving device, and more particularly, to an LED driving device for driving a plurality of LEDs based on stored data by sensing input power.

2. Discussion of the Background

A conventional LED driving circuit may drive LEDs using a converter, or use voltage rectified by bridge diodes without using a converter. A conventional LED driving circuit may drive LEDs using a smoothing circuit.

A conventional LED driving circuit that uses a converter may stably drive LEDs. However, the conventional LED driving circuit may have a problem with cost and size, and also may include an electrolytic capacitor that has a shorter operational lifetime than that of the LEDs. Even when a smoothing circuit is used in a conventional LED driving circuit, an electrolytic capacitor may also be used, so the shorter operational lifetime may also affect the smoothing circuit.

In a conventional LED driving circuit, an LED may be in an “off” state until a certain voltage is applied to the LED due to current-voltage characteristics of the LED. Therefore, the LED may be in a state where input current does not flow until an input voltage reaches the turn-on voltage of the LED. Such current-voltage operation characteristics may cause a power factor, which is defined by a ratio of input real power to input effective power, to be decreased, and harmonic components, to be increased.

### SUMMARY OF THE INVENTION

Exemplary embodiments of the present invention provide an LED driving device for driving LEDs without using a converter.

Exemplary embodiments of the present invention also provide an LED driving device that can control harmonic waves and a power factor and simultaneously prevent the brightness of LEDs from being varied due to changes in input voltage.

Exemplary embodiments of the present invention also provide an LED driving device that can improve the entire efficiency of an LED illuminator by improving the light emitting efficiency of LEDs.

Additional features of the invention will be set forth in the description which follows, and in part will be apparent from the description, or may be learned by practice of the invention.

An exemplary embodiment of the present invention discloses a light emitting diode (LED) driving device for an LED device having a plurality of LEDs, the driving device including a rectifying unit configured to receive an alternating current (AC) voltage and output a rectified voltage, and a driving control unit configured to drive the plurality of LEDs based on stored data by receiving the rectified voltage at a first period.

An exemplary embodiment of the present invention also discloses a light emitting diode (LED) driving integrated circuit (IC), including a power terminal to receive a first power, a connection terminal connectable to a first end of a first LED, and a control terminal connectable to a second end of the first LED, wherein the current flowing in the first LED is controlled through the control terminal based on the frequency of the first power.

It is to be understood that both the foregoing general description and the following detailed description are exemplary and explanatory and are intended to provide further explanation of the invention as claimed.

### BRIEF DESCRIPTION OF THE DRAWINGS

FIG. 1 is a block diagram showing an LED driving device according to an exemplary embodiment of the present invention.

FIG. 2 is a detailed block diagram of a synchronization signal and clock generator shown in FIG. 1.

FIG. 3 is a waveform diagram illustrating a driving data stored in a driving data storage.

FIGS. 4 and 5 are views showing an output of a digital controller.

FIG. 6 is a detailed block diagram of a constant current driving unit shown in FIG. 1.

FIGS. 7 and 8 are views illustrating the operation of the LED driving device according to the embodiment of the present invention.

FIG. 9 is a view showing voltage and current of an LED device according to an exemplary embodiment of the present invention.

FIG. 10 is a view showing power consumption of the LED device according to an exemplary embodiment of the present invention.

FIG. 11 is a view showing harmonic components in the LED driving device according to an exemplary embodiment of the present invention.

FIGS. 12 and 13 are views showing connection between an LED device and an LED driving device implemented as an integrated circuit (IC) according to an exemplary embodiment of the present invention.

### DETAILED DESCRIPTION OF THE ILLUSTRATED EMBODIMENTS

Hereinafter, exemplary embodiments of the present invention will be described in detail with reference to the accompanying drawings. The following exemplary embodiments are provided only for illustrative purposes so that those skilled in the art can fully understand the spirit of the present invention. Therefore, the present invention is not limited to the following exemplary embodiments but may be implemented in other forms. In the drawings, the widths, lengths, thicknesses and the like of elements are exaggerated for convenience of illustration. Like reference numerals indicate like elements throughout the specification and drawings.

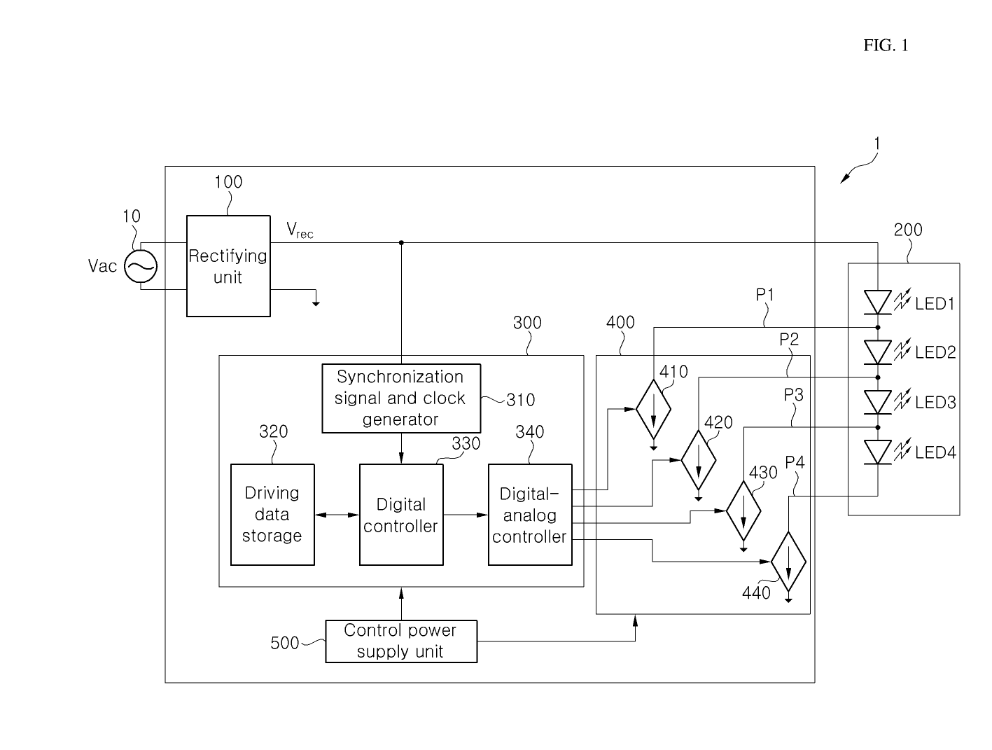

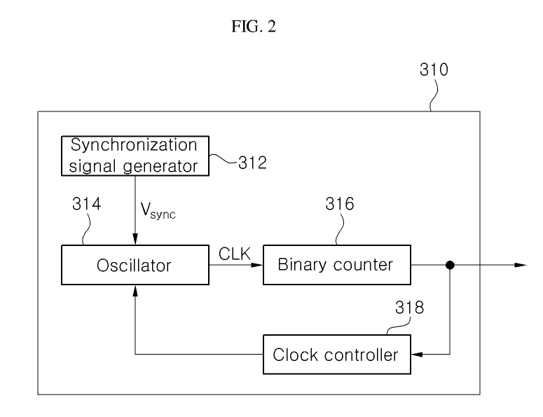

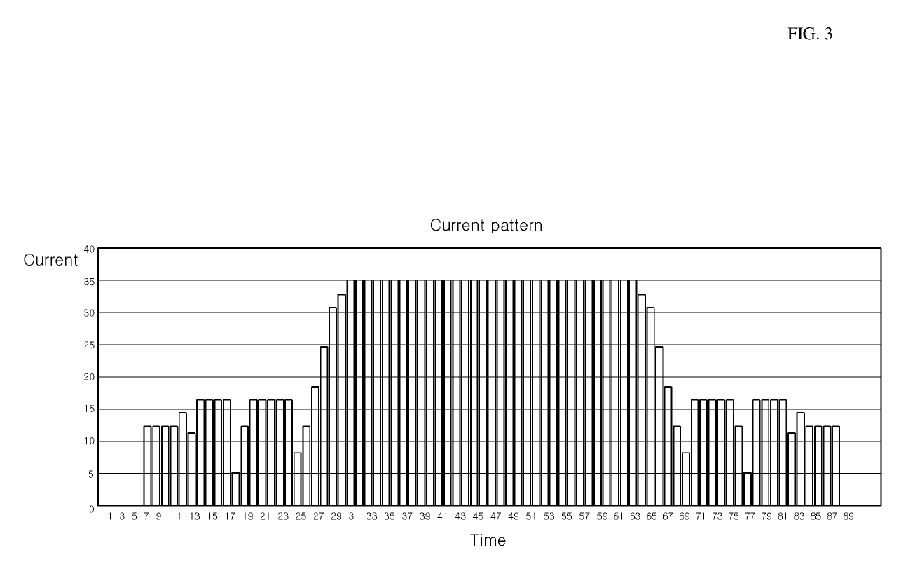

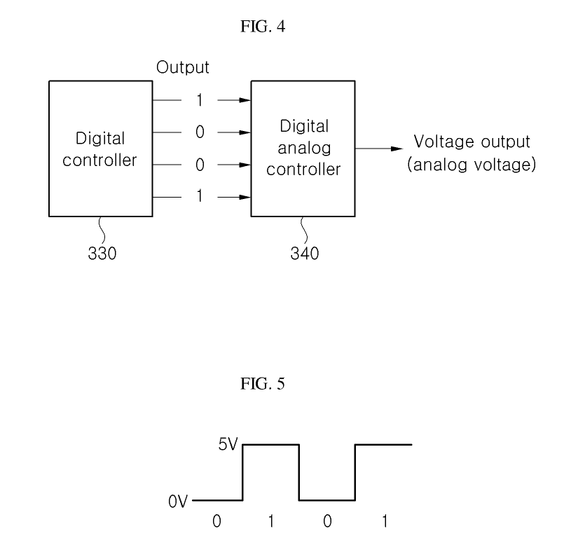

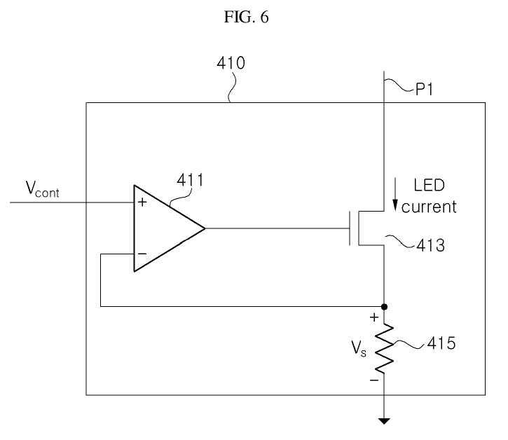

FIG. 1 is a block diagram of an LED driving device according to an exemplary embodiment of the present invention. FIG. 2 is a detailed block diagram of a synchronization signal and clock generator shown in FIG. 1. FIG. 3 is a waveform diagram illustrating a driving data stored in a driving data storage. FIGS. 4 and 5 are views showing an output of a digital controller. FIG. 6 is a detailed block diagram of a constant current driving unit shown in FIG. 1.

Referring to FIG. 1, the LED driving device 1 receives AC voltage Vac from a power source 10, and drives an LED device 200 using stored data based on the frequency of the AC voltage Vac. Here, the LED device 200 includes a plurality of LEDs (LED1, LED2, LED3, and LED4). Although an LED array in which four LEDs are connected in series is shown in FIG. 1, the present invention is not limited thereto. The number of LEDs that constitute an LED array, the number of LED arrays, and the number and connection structure of light emitting cells that constitute each of the LEDs may be varied without limitation if necessary. When the number of light emitting cells that constitute each LED is controlled, a threshold voltage may be controlled, and accordingly, it is possible to prevent a delay of the operation of the LED.

The LED driving device 1 according to the present exemplary embodiment includes a rectifying unit 100, a driving control unit 300, a constant current driving unit 400 and a control power supply unit 500. The rectifying unit 100 receives the AC voltage Vac from the power source 10 and full-wave rectifies the received AC voltage to output a rectified voltage Vrec. For example, the rectifying unit 100 includes bridge diodes.

The driving control unit 300 sets a predetermined period corresponding to the frequency of the rectified voltage Vrec, and selects a sub-period based on data obtained by counting the set period. Then, the driving control unit 300 outputs a driving control signal Vcont based on previously stored driving data corresponding to the selected sub-period.

Specifically, the driving control unit 300 may include a synchronization signal and clock generator 310, a driving data storage 320, a digital controller 330 and a digital-analog controller 340. The synchronization signal and clock generator 310 includes a synchronization signal generator 312, an oscillator 314, a binary counter 316 and a clock controller 318, as shown in FIG. 2. The synchronization signal generator 312 receives the rectified voltage Vrec and then outputs a synchronization signal Vsync synchronized with the frequency of the rectified voltage Vrec. The synchronization signal generator 312 may use an oscillation frequency several tens times higher than that of the rectified voltage Vrec. The synchronization signal generator 312 outputs the synchronization signal Vsync by limiting the rectified voltage Vrec to a predetermined voltage level or lower. In the present exemplary embodiment, a case where the rectified voltage Vrec is limited to a voltage level of 5 V will be described.

The oscillator 314 outputs a clock signal CLK with a predetermined period using the synchronization signal Vsync. The binary counter 316 counts the clock signal CLK to output binary data. Hereinafter, the data outputted from the binary counter 316 is referred to as a “count clock number”.

The clock controller 318 controls an operational frequency of the oscillator 314 based on the count clock number. The clock controller 318 receives a count clock number and compares the count clock number with a predetermined reference clock number to determine whether a difference between the count clock number and the reference clock number is within an error range. When it is determined that the difference between the count clock number and the reference clock number is within the error range, the operational frequency of the oscillator 314 is maintained. On the other hand, when it is determined that the difference between the count clock number and the reference clock number is not within the error range, the operational frequency of the oscillator 314 is increased or decreased. For example, the operational frequency of the oscillator 314 is increased when the count clock number is smaller than the reference clock number, and the operational frequency of the oscillator 314 is decreased when the count clock number is greater than the reference clock number. Accordingly, the count clock number in a period corresponding to the synchronization signal Vsync is set constant every period. Here, the reference clock number is set to a predetermined value based on the frequency of the AC voltage Vac.

The driving data storage 320 stores driving data for driving the LED device 200 at the sub-period. The driving data storage 320 includes an address corresponding to each sub-period, and stores driving data previously set at the address. Here, the sub-period is set based on the count clock number. In the present exemplary embodiment, a case where one period corresponding to the frequency of the rectified voltage Vrec is set to be divided into 90 sub-periods will be described. The driving data storage 320 includes a memory, for example a read-only memory (ROM). That is, the driving data storage 330 may be implemented in the form of a ROM cell for storing ROM data that enable a ROM-coding based current control. The ROM is generally composed of n bits by m words. When the LED device 200 includes a plurality of channels, the ROM data may have a current control bit, a pulse width modulation (PWM) control bit, an output control bit and the like for each channel so as to individually control the plurality of channels.

Further, the ROM data may have uppermost or lowermost two bits for modifying characteristics of the driving control unit 300 as reserved bits. The driving data according to the present exemplary embodiment is a value previously set in consideration of the number and characteristic of LEDs in the LED device 200, the size and frequency of the AC voltage Vac, the power consumption, power factor and harmonic characteristic of the LED device 200, and the like. The data includes the amplitude and pulsewidth of current for driving the LED device 200, information for selectively controlling the constant current driving unit 400, and the like. For example, the driving data may include information on the amplitude of current corresponding to 90 sub-periods, as shown in FIG. 3. In FIG. 3, the x-axis indicates time, and the y-axis indicates effective current.

The digital controller 330 determines a sub-period using the count clock number, and outputs a digital driving signal corresponding to the sub-period from the driving data storage 320. The digital controller 330 generates an address signal based on the count clock number, and generates a control signal for reading driving data corresponding to the address signal from the driving data storage 320. The digital controller 330 outputs a digital driving signal by reading the driving data based on the control signal. As shown in FIGS. 4 and 5, the digital controller 330 generates a digital driving signal of 0 V corresponding to binary data ‘0’, and a digital driving signal of 5 V corresponding to binary data ‘1’. The digital controller 330 generates an address signal whenever the count clock number is changed by the previously set value. In the present exemplary embodiment, a case where the digital controller 330 sequentially generates an address signal whenever the count clock number is increased by 16 will be described as an example.

The digital-analog controller 340 receives a digital driving signal from the digital controller 330 and outputs a driving control signal Vcont. The digital-analog controller 340 according to the present exemplary embodiment includes a plurality of switching elements (not shown), and outputs the driving control signal Vcont to one selected from a plurality of current sink units that constitute the constant current driving unit 400. The digital-analog controller 340 may simultaneously output the driving control signal Vcont to the plurality of current sink units that constitute the constant current driving unit 400. After converting the digital driving signal into an analog signal, the digital-analog controller 340 may modulate a pulse width of the converted analog signal and then output the analog signal as the driving control signal Vcont.

The constant current driving unit 400 controls current that flows in the LED device 200 based on the driving control signal Vcont. The constant current driving unit 400 includes the plurality of current sink units, and the number and arrangement of the current sink units is determined according to the number of LEDs that constitute the LED device, the number of LED arrays, and the arrangement of the LEDs. In the present exemplary embodiment, the constant current driving unit 400 includes first to fourth current sink units 410, 420, 430, and 440 corresponding to the four LEDs LED1, LED2, LED3, and LED4, respectively. Control terminals P1, P2, P3, and P4 of the first to fourth current sink units 410, 420, 430 and 440 are connected to cathode terminals of the corresponding LEDs LED1, LED2, LED3, and LED4, respectively.

Specifically, the first current sink unit 410, as shown in FIG. 6, includes an operational amplifier 411, a switching element 413, and a resistor 415. The first current sink unit 410 controls LED current so that the driving control signal Vcont is identical to a detection voltage Vs. The operational amplifier 411 includes a non-inverting terminal (+) where the driving control signal Vcont is inputted, and an inverting terminal (−) where the detection voltage Vs detected by the resistor 415 is inputted. The switching element 413 is connected between one end of a corresponding LED and one end of the resistor 415 to thereby be controlled by an output of the operational amplifier 411. Although the switching element 413 includes a metal oxide semiconductor field effect transistor (MOSFET), the present invention is not limited thereto. The other end of the resistor 415 is grounded. Since the LED current flows in the resistor 415 through the switching element 413, the detection voltage Vs is generated at both the ends of the resistor 415.

The control power supply unit 500 receives the AC voltage Vac from the power source 10, full-wave rectifies and drops the AC voltage Vac, and then outputs a control voltage Vcc for driving the driving control unit 300 and the constant current driving unit 400.

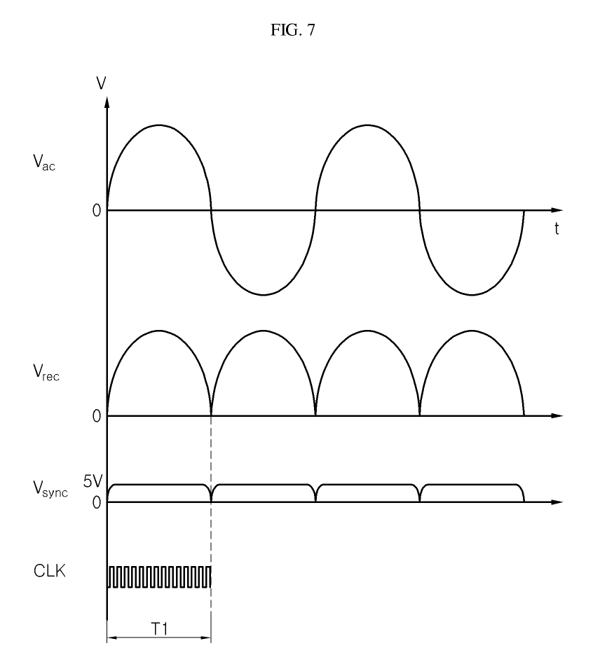

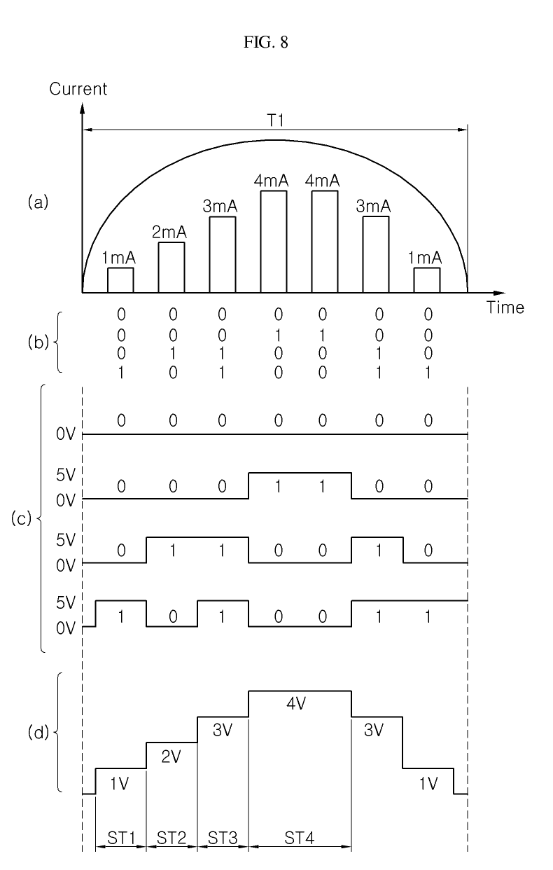

Hereinafter, the operation of the LED driving device according to an exemplary embodiment of the present invention will be described with reference to FIGS. 7 and 8. In the present exemplary embodiment, a case where the driving current for driving one LED is 1 mA will be described.

FIG. 7 is a waveform diagram showing an AC voltage Vac, a rectified voltage Vrec, a synchronization signal Vsync and a clock signal CLK. FIG. 8 is a schematic waveform diagram illustrating the operation of the digital controller 330 and the digital-analog controller 340.

Referring to FIG. 7, the rectifying unit 100 receives an AC voltage Vac and outputs a rectified voltage Vrec. Thereafter, the synchronization signal generator 312 drops the rectified voltage Vrec and outputs a synchronization signal Vsync. The synchronization signal Vsync has a period T1 corresponding to the frequency of the rectified voltage Vrec, and the oscillator 314 outputs a clock signal CLK having a count clock number set for every period T1 of the synchronization signal Vsync. The binary counter 316 counts the clock signal CLK and sends it to the digital controller 330.

Referring to FIG. 8, as shown in (a), the LED device 200 is set to be driven with a current of 1 mA during a first sub-period ST1, a current of 2 mA during a second sub-period ST2, a current of 3 mA during a third sub-period ST3 and a current of 4 mA during a fourth sub-period ST4. Then, as shown in (b), the first sub-period ST1 is set to an address signal A1, and as shown in (c), binary data ‘0001’ corresponding to the address signal A1 is stored in the driving data storage 320. In the same manner, the second sub-period ST2 is set to an address signal A2, and binary data ‘0010’ corresponding to the address signal A2 is stored. The third sub-period ST3 is set to an address signal A3, and binary data ‘0011’ corresponding to the address signal A3 is stored. The fourth sub-period ST4 is set to an address signal A4, and binary data ‘0100’ corresponding to the address signal A4 is stored.

Subsequently, if the count clock number outputted from the binary counter 316 becomes a predetermined number, e.g., 16, the digital controller 330 generates the address signal A1, and generates a first control signal for reading driving data corresponding to the address signal A1. Then, the digital controller 330 generates a digital driving signal corresponding to the address signal A1 in response to the first control signal during the first sub-period ST1. Thereafter, as shown in (d), the digital-analog controller 340 converts the digital driving signal outputted during the first sub-period ST1 into an analog signal, and then outputs the analog signal as a driving control signal Vcont of 1 V.

Similarly, if the count clock number is increased to 16, the digital controller 330 generates the address signal A2, generates a second control signal for reading driving data corresponding to the address signal A2, and generates a digital driving signal corresponding to the address signal A2 in response to the second control signal during the second sub-period ST2. Then, the digital-analog controller 340 outputs a driving control signal Vcont of 2 V.

Next, the operation of the constant current driving unit 400 and the LED device 200 will be described with reference to FIG. 1. If the application of the rectified voltage Vrec is started, current flows in the first LED LED1. At this time, the digital-analog controller 340 applies a first driving control signal Vcont_l of 1 V to the first current sink unit 410 during the first sub-period ST1. Then, current limited to 1 mA flows through the path P1, whereby the first LED LED1 emits light. Thereafter, the digital-analog controller 340 turns off the first current sink unit 410. Then, the voltage level of the rectified voltage Vrec is gradually increased, so that current flows in the first and second LEDs LED1 and LED2. At this time, the digital-analog controller 340 applies a second driving control signal Vcont_2 of 2 V to the second current sink unit 420 during the second sub-period ST2. Then, current limited to 2 mA flows through the path P2, so that the first and second LEDs LED1 and LED2 emit light. Similarly, a current of 3 mA flows through the path P3 during the third sub-period ST3, so that the first to third LEDs LED1 to LED3 emit light. That is, when the plurality of LEDs LED1 to LED4 emit light through the application of the rectified voltage Vrec, the amplitude of the current flowing in each LED is limited based on driving data previously stored at a sub-period, whereby the driving of the LED device 200 can be controlled regardless of a change in the rectified voltage Vrec.

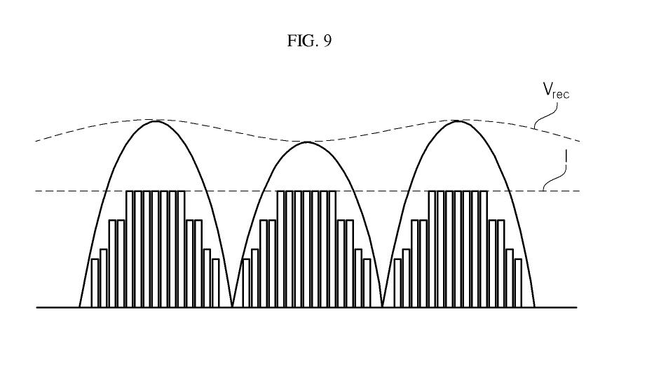

FIG. 9 is a view showing voltage and current of an LED device 200 according to an exemplary embodiment of the present invention. As shown in FIG. 9, it can be seen that the current I flowing in the LED device 200 is constant although the amplitude of the rectified voltage Vrec is changed.

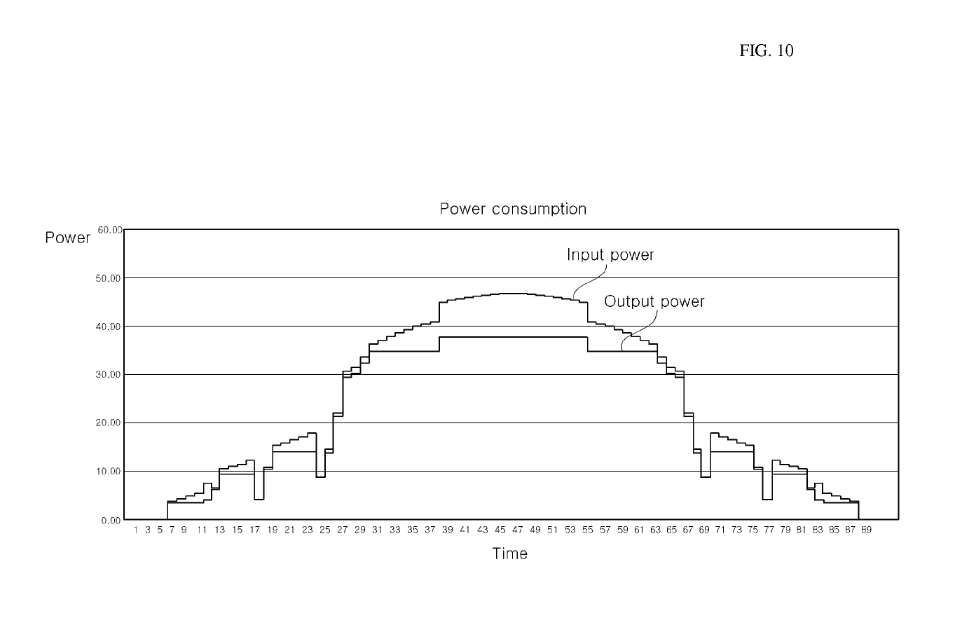

FIG. 10 is a view showing power consumption of the LED device 200 according to an exemplary embodiment of the present invention. In FIG. 10, the x-axis indicates time, and the y-axis indicates effective current. As shown in FIG. 10, since current for driving the LED device 200 is previously set, it is possible to control the power consumption of the LED device 200.

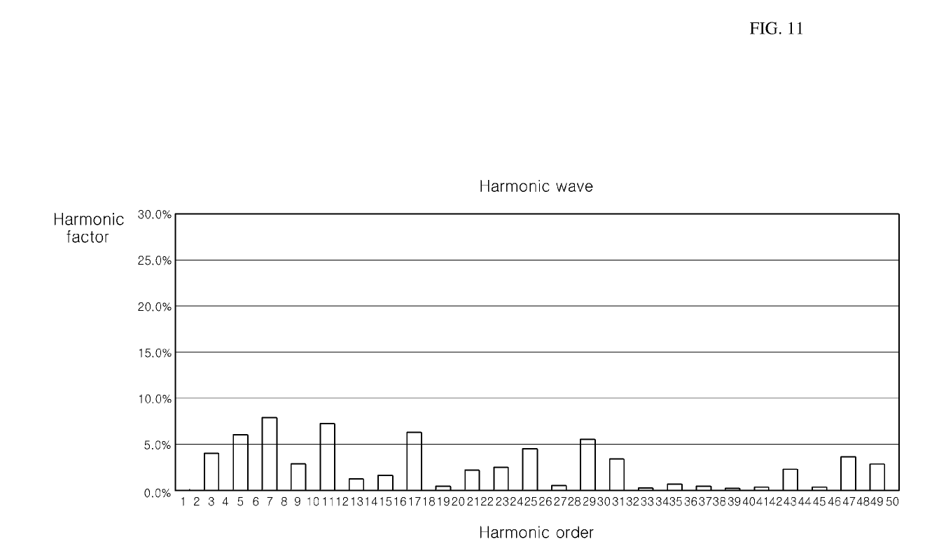

FIG. 11 is a view showing harmonic components in the LED driving device 1 according to an exemplary embodiment of the present invention. In FIG. 11, the x-axis indicates a harmonic order, and the y-axis indicates a harmonic factor. As shown in FIG. 11, it can be seen that only subharmonic components of 10% or less are partially shown as the driving data are previously set in consideration of harmonics of the AC voltage Vac.

The LED driving device 1 that has been described in FIGS. 1 to 11 may be implemented as one integrated circuit (IC) to be mounted in various light emitting devices. As the LED driving device 1 is implemented as an IC, it is possible to miniaturize a light emitting device.

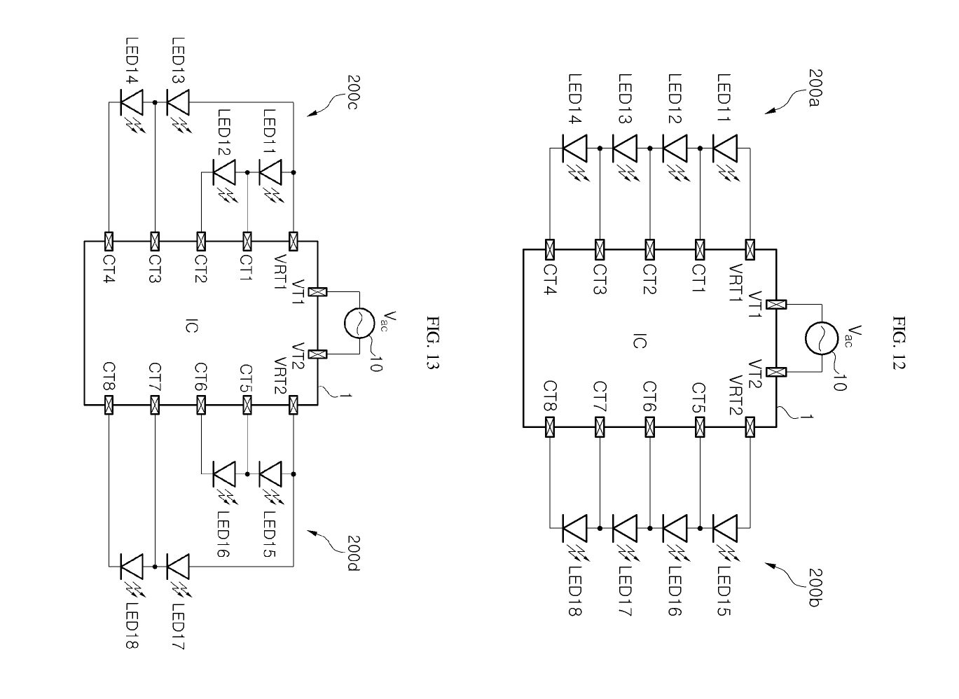

FIGS. 12 and 13 show connections between an LED device and an LED driving device implemented as an IC according to exemplary embodiments of the present invention.

As shown in FIGS. 12 and 13, the IC 1 according to the present exemplary embodiments includes first power voltage terminals VT1 and VT2 through which an AC voltage Vac is inputted from a power source 10; second power voltage terminals VRT1 and VRT2 through which a rectified voltage Vrec is inputted; and a plurality of connection terminals CT1, CT2, CT3, CT4, CT5, CT6, CT7, and CT8 respectively connected to cathode terminals of a plurality of LEDs LED11, LED12, LED13, LED14, LED15, LED16, LED17, and LED18. Here, the power source 10 supplies the AC voltage Vac. The connection between the IC 1 and the LEDs LED11 to LED 18 may be selected as shown in FIG. 12 or 13 according to the level of the AC voltage Vac. In the present exemplary embodiment, each of the LEDs LED11 to LED18 is configured as one LED chip having a plurality of light emitting cells, and a case where the turn-on voltage of each LED chip is 40 to 50 V will be described.

Specifically, in a case where the AC voltage Vac is 200 to 270 V, e.g., 220 V, the IC according to an exemplary embodiment of the present invention operates a first LED array 200a and a second LED array 200b as shown in FIG. 12. In the first LED array 200a, the first to fourth LEDs LED11 to LED 14 are connected in series to one another. In the second LED array 200b, the fifth to eighth LEDs LED15 to LED18 are connected in series to one another.

That is, when the AC voltage Vac is 200 to 270 V, e.g., 220 V, the first to fourth LEDs LED11 to LED 14 are connected in series to one another to constitute one channel. An anode terminal of the first LED LED 11 is connected to the second power voltage terminal VRT1, and the cathode terminal of the first LED LED11 is connected to the connection terminal CT1 and an anode terminal of the second LED LED12. The cathode terminal of the second LED LED12 is connected to the connection terminal CT2 and an anode terminal of the third LED LED13. The cathode terminal of the third LED LED13 is connected to the connection terminal CT3 and an anode terminal of the fourth LED LED14. The connection terminals CT1 to CT4 are respectively connected to the control terminals P1, P2, P3, and P4 of the first to fourth current sink units 410, 420, 430, and 440 shown in FIG. 1. The fifth to eighth LEDs LED15 to LED18 also constitute one channel, and are connected in the same manner as the first to fourth LEDs LED11 to LED14 are connected.

Meanwhile, when an AC voltage of 90 to 150 V, e.g., 110 V is supplied from the power source 10, the IC 1 according to an exemplary embodiment of the present invention operates a third LED array 200c and a fourth LED array 200d as shown in FIG. 13. In the third LED array 200c, the first and second LEDs LED11 and LED 12, which are connected in series to each other, are connected in parallel to the third and fourth LEDs LED13 and LED14, which are connected in series to each other. In the fourth LED array 200d, the fifth and sixth LEDs LED15 and LED 16, which are connected in series to each other, are connected in parallel to the seventh and eighth LEDs LED 17 and LED 18, which are connected in series to each other. The rectified voltage Vrec is applied to the first and second LEDs LED11 and LED 12 connected in series to each other and the third and fourth LEDs LED 13 and LED 14 connected in series.

Specifically, when the AC voltage Vac is 110 V, the first and second LEDs LED11 and LED 12 are connected in series to each other to constitute one channel. The anode terminal of the first LED LED11 is connected to the second power voltage terminal VRT1, and the cathode terminal of the first LED is connected to the connection terminal CT1 and the anode terminal of the second LED LED12. The cathode terminal of the second LED LED12 is connected to the connection terminal CT2. Similarly, the anode terminal of the third LED LED13 is connected to the second power voltage terminal VRT1, and the cathode terminal of the third LED is connected to the connection terminal CT3 and the anode terminal of the fourth LED LED 14. The cathode terminal of the fourth LED LED 14 is connected to the connection terminal CT4.

According to exemplary embodiments of the present invention, a plurality of LEDs that constitute an LED device is driven based on previously stored data by receiving an AC voltage, rectifying the received AC voltage, and then sensing the rectified voltage at a predetermined period, whereby it is possible to extend the lifetime of the LED device without using a converter. As the amplitude of the current flowing in the LED device is set based on the previously stored data, the LED device may maintain constant brightness regardless of the AC voltage even though the AC voltage is changed.

Also, according to exemplary embodiments of the present invention, the LED device is driven based on driving data corresponding to the characteristic of LEDs, the number of LEDs, the voltage and frequency of driving power, power consumption, efficiency required in various illumination regulations, a power factor, and harmonic specification, so that it is possible to optimize the light emitting efficiency of the LEDs and to ensure the operational reliability of the LED device.

The present invention is not limited to the aforementioned exemplary embodiments, and it will be understood by those skilled in the art that various modifications and changes can be made thereto. The modifications and changes are included in the spirit and scope of the present invention defined by the appended claims.

What is claimed is:

1. A light emitting diode (LED) driving device for an LED device having a plurality of LEDs, the driving device comprising:
a rectifying unit configured to receive an alternating current (AC) voltage and output a rectified voltage; and
a driving control unit configured to drive the plurality of LEDs based on stored data by receiving the rectified voltage at a first period.

2. The device of claim 1, wherein the driving control unit is configured to set the first period corresponding to a frequency of the rectified voltage, select a sub-period based on data obtained by counting the set first period, and output a driving control signal based on previously stored data corresponding to the selected sub-period.

3. The device of claim 2, wherein the driving control unit comprises:
a synchronization signal and clock generator configured to generate synchronization and clock signals based on the rectified voltage;
a driving data storage configured to store driving data for driving an LED device at the sub-period;
a digital controller configured to determine the sub-period using a count clock number generated in response to the synchronization and clock signals and output a digital driving signal corresponding to the sub-period from the driving data storage; and
a digital-analog controller configured to receive the digital driving signal from the digital controller and output the driving control signal.

4. The device of claim 3, wherein the synchronization signal and clock generator comprises:
a synchronization signal generator configured to receive the rectified voltage and output a synchronization signal synchronized with a frequency of the rectified voltage;
an oscillator configured to output a clock signal with a first period using the synchronization signal;
a binary counter configured to output binary data corresponding to the count clock number by counting the clock signal; and
a clock controller configured to control an operational frequency of the oscillator based on the count clock number.

5. The device of claim 4, wherein the synchronization signal generator outputs the synchronization signal by limiting the rectified voltage to less than or equal to a first voltage level.

6. The device of claim 4, wherein the clock controller increases or decreases the operational frequency of the oscillator based on a result obtained by comparing the count clock number with a first reference clock number.

7. The device of claim 6, wherein the first reference clock number is set based on a frequency of the AC voltage.

8. The device of claim 4, wherein the sub-period is set based on the count clock number.

9. The device of claim 3, wherein the driving data storage is configured to store an address corresponding to the sub-period, and store a first stored data at the address.

10. The device of claim 9, wherein the first stored data are set in consideration of the number and characteristic of the LEDs in the LED device, the amplitude and frequency of the AC voltage, and the power consumption, power factor, and harmonic characteristic of the LED device.

11. The device of claim 10, wherein the first stored data includes information on the amplitude and pulsewidth of current for driving the LED device.

12. The device of claim 3, wherein the driving data storage is configured to be implemented in the form of a read-only memory (ROM) cell for storing ROM data that enable a ROM-coding based current control.

13. The device of claim 12, wherein the ROM data is configured to individually control a plurality of channels and to have a current control bit, a pulse-width modulation (PWM) control bit, and an output control bit for each channel.

14. The device of claim 3, wherein the digital controller is configured to generate an address signal corresponding to the count clock number, a control signal for reading the driving data corresponding to the address signal from the driving data storage, and a digital driving signal corresponding to the driving data read in response to the control signal.

15. The device of claim 14, wherein the digital controller is configured to output the digital driving signal by reading the corresponding driving data in response to the control signal.

16. The device of claim 3, wherein the digital-analog controller is configured to convert the digital driving signal into an analog signal, and to output the driving control signal by modulating a pulse width of the converted analog signal.

17. The device of claim 1, further comprising a constant current driving unit configured to control current flowing in each of the LEDs in the LED device in response to the driving control signal.

18. The device of claim 17, wherein the constant current driving unit comprises a plurality of current sink units, and the number and arrangement of the plurality of current sink units is determined according to the number of the LEDs in the LED device, the number of LED arrays, or the arrangement of LED arrays.

19. The device of claim 18, wherein each current sink unit is configured to control current flowing in the LED so that the driving control signal is identical to a detection voltage of the LED.

20. The device of claim 19, wherein each current sink unit comprises:
a resistor comprising a grounded first end, the resistor to detect the detection voltage;
an operational amplifier comprising a non-inverting terminal configured to receive the driving control signal, and an inverting terminal configured to receive the detection voltage; and
a switching element connected at a first end to a corresponding LED and at a second end to the resistor, and configured to be controlled by an output of the operational amplifier.

21. The device of claim 1, further comprising a control power supply unit configured to supply a control voltage for driving the driving control unit.

22. The device of claim 1, wherein the driving control unit is implemented as an integrated circuit (IC) device.

23. A light emitting diode (LED) driving integrated circuit (IC), comprising:
a power terminal to receive first power;
a connection terminal connectable to a first end of a first LED; and
a control terminal connectable to a second end of the first LED,
wherein current flowing in the first LED is controlled through the control terminal based on the frequency of the first power.
